(19) United States
(12) Patent Application Publication
(10) Pub. No.: US 2023/0048694 A1
(43) Pub. Date: Feb. 16, 2023

(54) Micro-Power Generator Suitable for an Electronic Device, Electronic Device Comprising Such a Micro-Power Generator

(71) Applicant: KINETRON B.V., Tilburg (NL)

(72) Inventors: Sultan Tahyrovich Jumayev, Tilburg (NL); Wesley Peijnenburg, Tilburg (NL); Maarten Adrianus Hubertus Hoedjes, Tilburg (NL); Frans Vromans, Tilburg (NL)

(21) Appl. No.: 17/792,085

(22) PCT Filed: Jan. 8, 2021
(86) PCT No.: PCT/NL2021/050008

§ 371 Date: Jul. 11, 2022

(30) Foreign Application Priority Data
Jan. 10, 2020 (NL) 2024644

(51) Int. Cl. H02K 35/02; H02K 7/08

(52) U.S. Cl. CPC H02K 35/02; H02K 7/086; G04C 10/00

(57) ABSTRACT

Provided is a micro-power generator suitable for a wearable, portable or moving electronic device, including a rotor wheel including a multipole magnetic array of a circular design, such as a multipole magnetic ring or disc, which multipole magnetic array has an inner radius r3 and an outer radius r4, at least one stator which is a multipole metal stator including at least one stator coil having a plurality of windings for producing an electric voltage, and a base plate onto which the rotor wheel and the stator are mounted. The at least one stator is fixedly connected to the base plate. The rotor wheel is pivotally connected to the base plate by a pivoting mechanism which allows for a rotation of the rotor wheel about a pivot axis perpendicular to a first plane in which the rotor wheel extends, which pivot axis preferably has a concentric orientation to the rotor wheel. The rotor wheel is provided on one side of the base plate, and the rotor wheel has a centre of mass that has an eccentric position with respect to the pivot axis.

### CROSS-REFERENCE TO RELATED APPLICATIONS

This application is the United States national phase of International Application No. PCT/NL2021/050008 filed Jan. 8, 2021, and claims priority to The Netherlands Patent Application No. 2024644 filed Jan. 10, 2020, the disclosures of which are hereby incorporated by reference in their entirety.

### BACKGROUND OF THE INVENTION

### Field of the Invention

The present invention relates in a first aspect to a micro-power generator suitable for a wearable, portable or moving electronic device, and in a second aspect to a micro-power generator comprising a multitude of stators. Furthermore, in a third aspect the invention relates to an electronic device that comprises such a micro-power generator, in a fourth aspect to the use of such an electronic device in combination with a location tracking device and in a fifth aspect to suitable assemblies of such an electronic device with a location tracking device.

### Description of Related Art

The application of a micro-power generator for providing electricity to a wearable, portable or moving device, is well known in the relevant field of technology and has been notably evolving over the last decades.

Specific devices for which the micro-power generator has been proven suitable are watches, in particular smartwatches, wearable sensors and sensors on moving objects. Dependent on the specific device for which it is used, a micro-power generator is able to produce a power output in the range of several microwatt up to 10 Watt.

The main feature of the micro-power generator is that a pivotable rotor wheel comprising a magnetic ring is brought in rotation in concentric orientation to a stationary stator which comprises a stator coil with a plurality of windings. In the windings of the stator coil an electric voltage is produced based on the laws of electromagnetic induction, and the generator consequently forms a source of electric power. The size of the generator, its electromagnetic properties, the number of poles of the magnetic ring, the number of poles of the stator and the number of windings of the stator coil determine the amount of electrical voltage and power that can be produced.

In a commonly applied micro-power generator that is known from the art, the rotor wheel is driven over a set of transmission gears that is driven by the pivotal movement of an eccentric weight that is pivotally connected to a base plate or other type of fixed body. The pivotal movement of the eccentric weight is herein accelerated via the set of transmission gears by a factor 40, such that the rotor wheel is rotating at a considerably higher speed. Such a micro-power generator is able to produce a useful voltage for micro-power applications, while both the rotor wheel and the stator can be kept of relatively small dimensions.

The kinetic energy that puts the eccentric weight in motion, stems from the movements that the micro-power generator as a whole makes while being in motion, such as during its use as part of a wearable or portable device.

Although useful in many respects, the known micro-power generator suffers from several disadvantages due to the following aspects:
a significant loss of power output is observed due to an intrinsic frictional loss of kinetic energy over the transmission gears, both at low speeds of movement and in particular at high speeds of movement;
to comply with reliability requirements of the gear transmission, additional mechanical rectifiers are needed as well as shock absorbing means which complicate the construction of the micro-power generator as a whole and further increase the frictional losses and therefore reduce the efficiency and power output of the micro-power generator;
the limited size of the rotor and stator cause significant electromagnetic losses at higher speeds, reducing the electromagnetic efficiency and therefore reducing and limiting the power output at lower speeds and reducing and limiting the intended increase of power output at higher speeds;
the accelerating gears and numerous mechanical components lead to significant noise and wear during power generation;
the production of the generator is generally cumbersome and costly in view of all components needed.

### SUMMARY OF THE INVENTION

It is therefore an object of the invention to develop a micro-power generator wherein the above disadvantages related to the known generator do no longer exist or are at least significantly reduced.

Furthermore, it is a general object of the invention that the micro-power generator has a compact overall size, and has a high durability in regard of any of the static and moving parts of the construction.

In addition, it is required that the generator is easily mechanically mountable within an electronic device that it supplies power to and is easily electrically connectable to an electric circuit of the device.

The above object of the invention is achieved, according to a first aspect of the invention, by the provision of:

a micro-power generator suitable for a wearable, portable or moving electronic device, comprising:
a rotor wheel comprising a multipole magnetic array of a circular design, such as a multipole magnetic ring or disc, which multipole magnetic array has an inner radius r3 and an outer radius r4,
at least one stator which is a multipole metal stator comprising at least one stator coil having a plurality of windings for producing an electric voltage,
a base plate onto which the rotor wheel and the stator are mounted, wherein:
the at least one stator is fixedly connected to the base plate,
the rotor wheel is pivotally connected to the base plate by a pivoting mechanism which allows for a rotation of the rotor wheel about a pivot axis perpendicular to a first plane in which the rotor wheel extends, which pivot axis preferably has a concentric orientation to the rotor wheel,

and wherein the rotor wheel is provided on one side of the base plate, and the rotor wheel has a centre of mass that has an eccentric position with respect to the pivot axis.

As the rotor wheel according to the invention is provided with an eccentric centre of mass and comprises a magnetic array, it enables the use of a larger rotor and stator then currently feasible in a micro-power generator according the prior art, while it requires no gear transmission nor any additional mechanical components or any torsion springs which are needed in a micro-power generator according to the prior art. Hence, the micro-power generator according to the invention is typically a gearless micro-power generator, also referred to as a direct-drive micro-power generator. Consequently, the invention achieves less frictional loss of kinetic energy, a raised efficiency of electric power produced, a lower risk of malfunctioning of the micro-power generator and reduced noise and wear. Furthermore, the invention allows for an easy, preferably completely axial, assembly and lower costs of production of the micro-power generator.

In addition, the rotor wheel having an eccentric centre of mass and provided on one side of the base plate, is of a compact design which is advantageous for the overall size of the generator. Furthermore the opposed side of the base plate which is not provided with a rotor wheel, is conveniently accessible for providing any mechanical and electronic connections with the device in which the generator is integrated.

Within the context of the invention, the pivot axis should be construed as a virtual axis which defines the rotation of the rotor wheel.

The multipole magnetic array may be part of, assembled to, or attached to the rotor wheel and may be formed by individual magnet segments or one or more multipole magnetic rings or alternatively by one or more multipole magnetic discs.

Furthermore, a stator may comprise one or more individual stator parts and the micro power generator may comprise one or more multipole stators, preferably axially and concentrically stacked.

Furthermore, a stator comprises one or more stator coils having a plurality of windings for producing an electric voltage.

Finally, within the context of the invention, the base plate may be any type of body or structural element suitable for supporting both the stator and rotor.

It is preferred that in the micro-power generator, an angular section of the rotor wheel is provided with at least one body of mass, which body of mass is fixedly connected to the multipole magnetic array as an integral part of the rotor wheel, and which body of mass extends in a radial direction from the outer circumference of the multipole magnetic array.

The body of mass may for instance be fixated onto the rotor wheel by a screw connection, by riveting, by (ultrasonic) welding, by a clamping connection or by gluing. Alternatively, the body of mass may be an integral part of the rotor wheel and/or multipole magnetic array.

The body of mass determines for a major part the eccentric position of the centre of mass of the rotor wheel as a whole, this effect being dependent on the specific shape of the body of mass and its position onto the multipole magnetic ring or disc.

In particular, it is preferred that the angular section of the rotor wheel has a size which is determined by an angle theta which lies in the range of 60° and 300°, preferably of 90° and 180°, more preferably of 120° and 170°.

Furthermore, it is attractive that the body of mass comprises a ring sector defined as an angular section of a ring that has a concentric orientation to the multipole magnetic array, wherein the ring sector has an outer radius r6, wherein r6 is larger than r4, and wherein the size of the angular section is determined by an angle theta which lies in the range of 60° and 300°, preferably of 90° and 180°, more preferably of 120° and 170°.

Such a size and shape of the angular section of the rotor wheel comprising the body of mass assures an optimum efficiency of harvesting kinetic energy from the motion of the generator as a whole, and transforming this energy in rotational energy for the rotor wheel. Preferably the main part of the body of mass is made from a metal having a relatively high density such as 6000 kg/m3 or higher, and preferably is corrosion-resistant, such as Tungsten, brass and stainless steel. Other parts of the body of mass may be made from a more light weight material if practical feasible.

For practical reasons, it is an additional preference in the context of the invention that r6 is equal to r4, or not larger than 2.0 times r4 up to 2.5 times r4. In that way, the micro-power generator as a whole has relatively compact dimensions in view of the intended use of the generator.

It is in addition preferred in the micro-power generator according to the invention, that the body of mass is connected to the multipole magnetic array by a substantially planar body which comprises either:
a mounting bracket that is releasably attached onto the body of mass and the multipole magnetic array; or
a disc portion that is fixedly attached to the body of mass and the multipole magnetic array.

Preferably the planar body, in particular when in the form of a mounting bracket, is made of a material that has a relatively low weight in comparison to the weight of the body of mass. As such the body of mass contributes for the largest part to the eccentricity of the centre of mass of the rotor wheel.

Additionally, the mounting bracket may be designed such that it has in itself an asymmetric distribution of mass that further contributes to the eccentricity of the centre of mass of the rotor wheel.

When the planar body is in the form of a disc portion, it is preferred that its size in terms of the angular section of the disc is determined by an angle theta which lies in the range of 60° and 360°, preferably of 90° and 180° more preferably 120° and 170° and most preferably of 120° and 170°. The radius of the disc portion is preferably not larger than an outer circumference of the body of mass.

The disc portion may be made from the same material as the body of mass that is attached to it, preferably a relatively high density material: as such the body of mass and the disc portion can be produced as one single piece made from one material.

The mounting bracket or disc portion is preferably provided on an upper side of the generator which side is opposite to a bottom side of the generator where the base plate or other type of fixed housing is positioned.

In general it is preferred in the generator according to the invention, that the pivoting mechanism is single sided such that it forms a single pivotal connection between the rotor wheel and the base plate. Such a single sided pivoting mechanism establishes a relatively simple connection between the rotor wheel and the base plate at one single position with respect to the first plane of the rotor wheel. Such an embodiment does not contain two separate pivoting mechanisms that are for instance positioned on two opposed sides of the first plane of the rotor wheel.

The advantage of using one single sided pivoting mechanism is that the generator allows for a compact, and visually attractive design, which furthermore achieves a low frictional loss of energy. Additionally, by limiting the pivoting mechanism to a single sided pivoting mechanism a more reliable mechanism is accomplished because the occurrence of any unwanted defects is limited to one single unit.

It is preferred in the micro-power generator according to the invention, that the pivoting mechanism for the rotor wheel comprises a central shaft which coincides with the pivot axis, and which central shaft is fixedly connected to the base plate.

As the central shaft is fixedly connected onto the base plate, an attractive, durable construction is provided as a basic part of the pivoting mechanism. The rotor wheel is herein pivotally mounted onto the central shaft.

As an alternative to this embodiment, the pivoting mechanism for the rotor may be provided in a mechanically reversed manner, wherein the central shaft that coincides with the pivot axis, is fixedly connected to the rotor wheel itself. The base plate is herein pivotally mounted onto the central shaft.

Furthermore, it is preferred that in the micro-power generator the pivoting mechanism for the rotor wheel comprises at least one friction reducing support element such as a bearing, which is mounted with a concentric orientation to the pivot axis, and preferably is mounted in the first plane and/or on one side of the first plane.

Further preferred in this context, is that the at least one friction reducing support element is a bearing that is positioned within the inner radius r3. As such the bearing comprising an inner race and an outer race which are of smaller dimensions than the inner radius r3, and preferably within the inner circumference of the stator.

Such a bearing allows for a compact overall size of the generator, and is especially suitable when an inner race of the bearing is connected to a central shaft that is fixed to the base plate, and an outer race of the bearing is connected to the rotor wheel. Alternatively, the above embodiment may be mechanically reversed, such that the central shaft is fixed to the rotor wheel while the outer race of the bearing is connected to the base plate.

As an alternative or additional embodiment to the above, the friction reducing support is a bearing, which is connected to the base plate and to the multipole magnetic array, and is mounted radially beyond the inner radius r3 of the multipole magnetic array, and preferably radially beyond the outer radius r4 of the multipole magnetic array.

As such, the ball bearing may be mounted outside of the circumference of the multipole magnetic array, in such a way that an outer race of the bearing is fixedly connected to the base plate and an inner race of the bearing is fixedly connected to the rotor wheel. Also such a bearing allows for a compact construction of the whole generator.

By using one of the above support elements, a minimization of frictional loss of kinetic energy of the rotor wheel is achieved, and a consequent maximization of the electric power produced by the generator.

Preferably, in the micro-power generator according to the invention, the multipole magnetic array and the stator of annular shape are mounted in a concentric orientation to each other and to the pivot axis, and both extend in the first plane on one side of the base plate.

As such, the stator has an advantageous shape to electromagnetically interact with the rotor wheel, in particular with a multipole magnetic ring or disc, and the generator may have a compact overall size.

Further preferably in the micro-power generator, the stator has an annular shape which is delimited by an inner radius r1 and an outer radius r2, and the inner radius r3 of the multipole magnetic array is larger than the outer radius r2 of the stator. This specific construction wherein the rotor wheel is positioned outside of the circumference of the stator, has proven most effective and efficient for the generation of electrical power.

As an alternative to the above preference, the multipole magnetic ring or disc and the stator of annular shape may be mounted parallel to each other wherein the stator extends in a plane that is different from the first plane. In such a case, the magnetic ring or disc and/or the stator may have an inner and/or outer radius of a comparable value. In this case the magnet rotates axially above or below the stator.

In an effective, and therefore preferred embodiment of the micro-power generator according to the invention, the centre of mass of the rotor wheel has a distance dcm, measured from the pivot axis and in a plane perpendicular to the pivot axis, which is, considering the dimensional and mass constraints of the micro power generator, preferably equal to or larger than r3, preferably equal to or larger than (r3+r4)/2, and most preferably equal to or larger than r4.

In general, the larger the distance dcm, the further the eccentric position of the centre of mass from the pivot axis, and hence the larger the amount of kinetic energy that will be harvested by the rotor wheel from the movements of the generator as a whole while being in motion.

When the micro-power generator as a whole should have relatively compact dimensions for its intended application, it is further preferred that the distance dcm is limited to a maximum value of 1.5 times r4 up to 2.0 times r4.

The body of mass that is part of the rotor wheel, has a centre of mass in itself at a position which is at a distance measured from the pivot axis and in a plane perpendicular to the pivot axis, that falls in the same range as the dcm value set out above for the centre of mass of the rotor wheel as a whole.

In the micro-power generator according to the invention, the body of mass is preferably made from a metal having a density of 6000 kg/m3 or higher, and preferably is corrosion-resistant, such as Tungsten, brass and stainless steel.

A suitably high density range for the body of mass lies in the range of 6,000 to 20,000 kg/m3.

It is furthermore preferred in the micro-power generator according to the invention, that the body of mass has a weight ratio to the multipole magnetic ring or disc which is at least 1, preferably at least 2, and more preferably at least 4.

As such, the body of mass determines for the largest part the eccentric position of the centre of mass of the rotor wheel as a whole.

In practice, typically a weight ratio in the range of 3 up to 10 is most useful, although even higher ratios may be encompassed by the invention.

It is further preferred in the micro-power generator, that the ring sector has a height equal to or larger than the height of the multipole magnetic ring or disc. Such relative dimensions allow for an efficient use of space within the whole construction.

In respect of the size of the micro-power generator according to the invention, it is preferred that the generator has a height of 2 up to 25 mm, and that the rotor wheel has a diameter of 20 up to 100 mm, preferably 20 up to 35 mm.

Any generator has a general characteristic which is referred to as cogging torque, which is a an intrinsic effect that results from the interaction between the metal stator and the magnetic rotor and affects the transformation of kinetic energy into electrical energy of the micro power generator. The cogging torque of a generator is primarily dependent of the electromagnetic properties and design of the stator and rotor.

In the view of the desired cogging torque of the generator according to the present invention it is preferred that the cogging torque of the generator, including additional friction losses, is lower than the maximum static torque of the rotor wheel, which is at 90 degrees and in a vertical position of the micro power generator. More specific the cogging torque, including additional friction losses, is equal to the torque of the rotor wheel between 30 to 60 degrees in a vertical position of the micro power generator. These angles are also known as the cogging torque angle.

By pre-defining the cogging torque in the above manner, the drop angle of the rotor wheel in vertical position can be set, enabling an increase of generated energy at slow rotations of the micro-power generator because potential energy is stored into the eccentric weight of the rotor wheel and released to the stator when the rotor wheel drops, also referred to as a weight drop. The weight drop occurs when the rotor wheel rotational angle relatively to the base plate exceeds the cogging torque angle as described above. In this way a low rotational speed of the micro-power generator can result in multiple drops of the rotor wheel at higher speed, generating a higher voltage and a more efficient power generation.

To assure significant power generation at low speeds of the rotor wheel the further following properties of the stator and multipole magnetic ring or disc are preferred:

In the micro-power generator according to the invention, the multipole magnetic array, preferably a multipole magnet ring or disc, preferably comprises 4 up to 100 magnetic poles, in particular 10 up to 60 magnetic poles.

It is noted that the individual poles in a multipole magnetic ring or disc are commonly arranged in respective adjacent segments along the arc of the multipole magnetic ring or disc.

In the micro-power generator according to the invention, the stator coil is preferably surrounded by an electromagnetic enclosure which interacts with the electromagnetic field of the rotor wheel in order to promote an induction effect in the windings of the stator coil, or multiple stator coils.

The electromagnetic enclosure is typically formed by a multitude of adjacent electromagnetic strips that surround respective adjacent parts of the stator coil. These strips are also referred to in the art as stator legs, and are electrically isolated from the windings of the stator coil.

It is further preferred that the electromagnetic enclosure extends over the complete stator coil. Typically a number of 4 up to 100, in particular 10 to 60, adjacent strips are used to construct an effective electromagnetic enclosure for the stator coil.

Effectively, the electromagnetic enclosure as such accomplishes that the stator as a whole functions as a multipole metal stator.

It is further preferred in the micro-power generator according to the invention that a first end and an opposed second end of the stator coil or stator coils are electrically connectable to an electrical circuit of a device for which the micro-power generator is suitable.

In case of multiple stator coils the first and second end of each coil can be linked to the electric circuit and/or the multiple coils can be linked together in parallel or in series before being connected to the electric circuit.

As such a micro-power generator is rendered which can directly be used for its intended purpose of generating energy and signals. The micro-power generator produces the following signals: voltage, current and frequency. The signals allow to deduce the rotational speed, acceleration and (incremental) rotational angle of the rotor wheel. The signals and the inducted information can subsequently be used by an electronic device connected to the micro-power generator.

In a special second aspect, the invention relates to a micro-power generator comprising at least two stators according to the invention, wherein one stator produces a signal having a shifted phase with respect to the signal of another stator.

Such a system allows, besides deduction of speed, acceleration and (incremental) rotational angle, to deduce also the rotation direction—clockwise or counter-clockwise—of the rotor wheel that has been set in motion, from the different signals generated according to the phase difference between the two signals. The signals and the deducted information can subsequently be used by an electronic device connected to the micro-power generator.

A third aspect of the invention relates to a device, such as a watch, in particular a smartwatch, a wearable sensor or a sensor on moving objects, which device comprises an electrical circuit and a micro-power generator according to the first or second aspect of the invention, wherein the electrical circuit is connected to the micro-power generator.

As such, a device is rendered which can be directly used for its intended purpose. The power output from the micro-power generator powers the electronic device to reduce or eliminate the replacement or recharging of batteries and preferably totally eliminate the use of batteries.

In the device, the micro-power generator produces at least the following signals: voltage, current and frequency. These signals vary during use of the device as a result of the motion of the object to which the device is attached and the related rotation of the rotor wheel of the micro-power generator.

In the device according to the third aspect of the invention, it is accordingly preferred that the varying signals that the micro-power generator produces, are used, directly or indirectly, by the electronic circuit of the device, preferably in determining the movement of the rotor wheel of the micro-power generator, the micro-power generator and/or the motion of the device and/or the object to which it is attached.

During the use of a device which is connected to a moving object, the varying values of the signals of the micro-power generator can be used to derive the movement of the micro-power generator and the motion of the device and/or the object to which the device is attached. It is in this context advantageous that the device additionally produces specific signals that are related to the rotational speed, acceleration, (incremental) rotational angle and/or rotational direction of the rotor wheel of the micro-power generator and the related movement of the micro-power generator, the device and/or the object to which the device is attached.

Therefore, a preferred embodiment of the device according to the invention, comprises a device,
wherein the micro-power generator is configured to produce at least one signal related to the movement of the rotor wheel,
and wherein the electrical circuit of the device is powered by the micro-power generator
and wherein the electrical circuit comprises a processor that is configured to, directly or indirectly, receive the at least one signal produced by the micro-power generator and uses the signal, preferably for creating functions within the device and/or preferably to transform the signal into an output signal representative for the movement of the rotor wheel of the micro-power generator and/or the related motion of the device and/or the object to which the device is attached.

The signals produced by the micro-power generator relating to its output, may require additional signal producing elements in the form of electric switches, reed contacts, hall sensors, etc. These elements may be added to the micro-power generator, in particular to its pivoting or moving parts.

The characteristics of the signals produced by the generator may vary with the rotational speed, the acceleration, the rotational direction, the position, and/or the incremental position of the rotor wheel with respect to the base plate.

For example, the signals of the micro-power generator can be used by the processor to activate the electronic circuit from deep sleep mode when motion is present, in order to reduce power consumption when no energy is being generated. Another example is that the signals may be used by the processor to describe the motion of the object to which the micro-power generator is attached and more specific may describe the activity, (rotational)speed, (rotational)direction, acceleration, travelled distance, revolutions turned, (incremental)position of the object. This information might be used for functionality of the electronics or the device, they might be stored and/or transmitted. An more detailed example is that the device is attached to a wheel and based on the rotation of the wheel and subsequently the signals created by the device due to the rotation of the rotor wheel of the micro power generator the device wakes up when the wheel starts moving, is activated to send a output signal every 10 revolutions and calculates based on the signals the horizontal speed and travelled distance of the wheel.

The electrical circuit of the device may further comprise:
a rectifier for rectifying the voltage from AC to DC, a capacitor or rechargeable battery for storage of the energy, a microprocessor for power management and programming of the functionality of the product, a wireless transmitter and other components required for the overall product functionality.

Further preferred in the device according to the invention, is that the processor produces an output signal which is representative for the activity, (rotational)speed, (rotational)direction, acceleration, travelled distance, revolutions turned, (incremental)position of the device or the (living) object to which the device is attached.

In another preferred embodiment of the device according to the invention, the device comprises a preprogramed signal processor, in which preferably at least one cross-reference between at least one signal related characteristic and at least one output signal related characteristic are stored, wherein the processor is configured to transform at least one signal into at least one output signal by making use of said preprogramed signal processor.

A fourth aspect of the invention, is related to the use of a device according to the third aspect of the invention, in combination with a location tracking device, for example a GPS or Wifi, Bluetooth or cellular tracking system, to generate combined data of both devices.

In addition, it is advantageous when such use further encompasses the provision of the combined data in a presentable format to be monitored by a user of the signal producing device, or by a remote supervisor.

A fifth aspect of the invention is related to an assembly of a device according to the third aspect of the invention and a location tracking device, which assembly is configured to generate combined data from both devices.

As a preferred embodiment, the assembly is a wearable device for humans or animals, or a device that is mountable onto a moving object, such as a wheel of a moving object.

### BRIEF DESCRIPTION OF THE DRAWINGS

The invention will be further illustrated by the appended drawings of several non-limitative examples of a micro-power generator according to the invention.

In the appended drawings:

FIG. 1A shows a top view of a first preferred embodiment of the invention;

FIG. 1B shows a cross-sectional view of the first preferred embodiment of the invention;

FIG. 2A shows a top view of a second preferred embodiment of the invention;

FIG. 2B shows a cross-sectional view of the second preferred embodiment of the invention;

FIG. 3A shows a perspective view of a third preferred embodiment of the invention; and

FIG. 3B shows a cross-sectional view of the third preferred embodiment of the invention.

### DESCRIPTION OF THE INVENTION

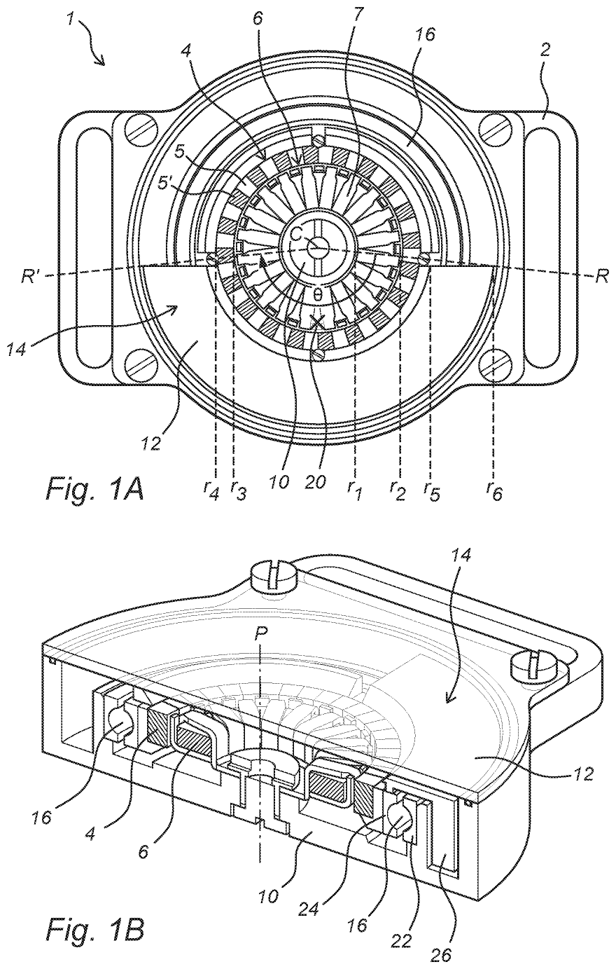

FIG. 1A shows a top view of a micro-power generator 1 which is attached to a strap bracket 2 which is useful when the generator 1 forms an integral part of a wearable or portable device which is to be strapped to a user's wrist, an animal's neck, or to a part of a moving object.

The generator 1 is composed of a multipole magnetic ring 4 having an inner radius r3 and an outer radius r4, and a stator 6 of an annular shape which is delimited by an inner radius r1 and an outer radius r2. The radii r1, r2, r3 and r4 are defined with respect to centre point c of the generator.

The individual poles on the multipole magnetic ring 4 are arranged as alternating adjacent segments 5, 5′. The total number of individual poles is 40. The stator 6 contains 40 poles and the stator 6 contains a stator coil 7, of which the total number is 1460.

The stator 6 and multipole magnetic ring 4 are concentrically positioned to each other with respect to centre c, and substantially in coplanar orientation with each other. The stator is fixedly connected to an underlying base plate 10, of which a central part is visible. All elements of the generator 1 that are shown in FIGS. 1A/1B, are thus provided on one side of the base plate 10, i.e. the upper side of the base plate 10.

The multipole magnetic ring 4 is fixedly connected to a body of mass 12 which together form the rotor wheel 14. The rotor wheel 14 is pivotally connected to the base plate 10 by a pivoting mechanism in the form of a ball bearing 16 which allows for a rotation of the rotor wheel about a pivot axis. This pivoting mechanism 16 is single sided such that it forms a single pivotal connection between the rotor wheel and the base plate.

The ball bearing 16 surrounds the outer radius r4 of the multipole magnetic ring 4. The pivot axis coincides with the centre c and has a perpendicular orientation to a first plane in which the rotor wheel 14 and the stator 6 are present. Due to the body of mass 12, the rotor wheel 14 as a whole has a centre of mass at the location 20 indicated by an x in the figure. The centre of mass 20 has a distance to centre c, which is about the value of r2 or r3. As such, the centre of mass 20 has an eccentric position with respect to the centre point c and hence with the pivot axis.

The body of mass 12 has the form of a ring sector 12 defined as an angular section of a ring that is in concentric position to the multipole magnetic ring 4, wherein the ring sector has an inner radius r5 and an outer radius r6 and wherein the size of the angular section is determined by an angle theta between lines R and R′ which is about 170°.

As such, the rotor wheel extends in a first plane which is a horizontal plane that intersects the multipole magnetic ring 4.

In FIG. 1B, the parts already described in respect of FIG. 1A, are indicated by the same reference numerals.

FIG. 1B further shows the pivot axis p which intersects the centre point c of the generator, and the ball bearing 16 which contains an inner race 24 that is fixed onto the rotor wheel 14, and an outer race 22 which is fixed onto the base plate 10. The ball bearing 16 thus effectively allows for a rotation of the rotor wheel about the pivot axis P.

The ring sector 12 includes a vertical part 26 which determines the height of the ring sector 12 and which part 26 extends over a same angular section as the ring sector 12. By virtue of inner race 24, the ring sector 12 is fixedly connected to the multipole ring 4, and provided as a radial extension beyond the outer radius r4 of the multipole ring 4.

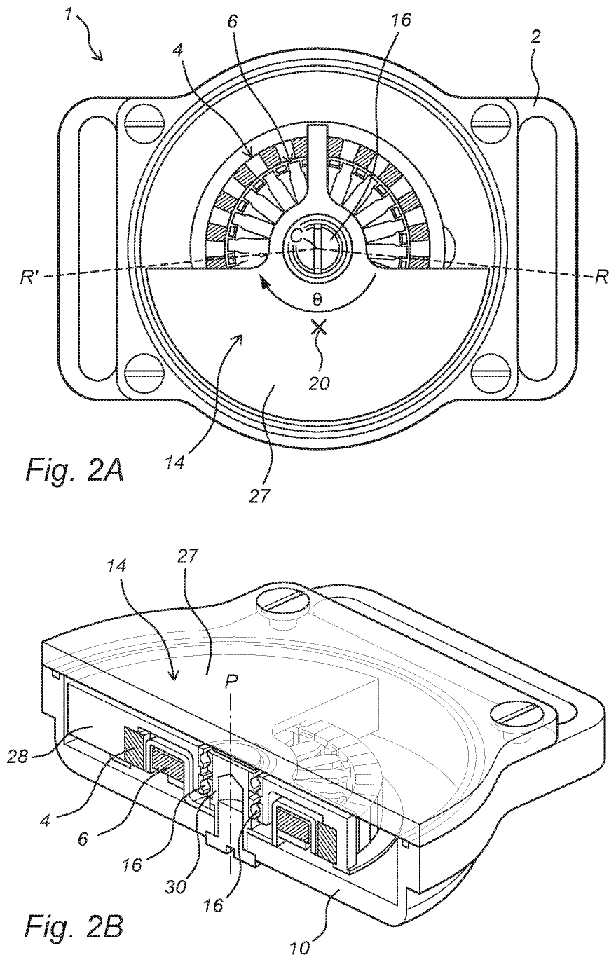

FIG. 2A shows a micro-power generator 1, which contains a multipole magnetic ring 4 and a stator 6, having similar properties as the multipole magnetic ring 4 and a stator 6 shown in FIG. 1A, except where stated otherwise below.

A body of mass 27 includes on the upper side a disc portion that is fixedly attached to a ring sector 28 (not visible, see FIG. 2B) and to the multipole magnetic ring 4, which elements together form the rotor wheel 14. The disc portion is an angular section of a disc that has a concentric orientation to the stator 6. The size of the disc portion is determined by an angle theta between lines R and R′ which is about 170°. Due to the body of mass 27, the rotor wheel 14 as a whole has a centre of mass at the location 20 indicated by an x in the figure. The centre of mass 20 of the rotor wheel thus has an eccentric position with respect to the centre point c and hence with the pivot axis.

The rotor wheel 14 is pivotally connected to the base plate 10 (not visible, see FIG. 2B) by a pivoting mechanism in the form of a ball bearing 16 which allows for a rotation of the rotor wheel about the pivot axis P of the ball bearing 16. The ball bearing 16 is mounted within the inner radius r1 of the stator 6 and connected to the base plate by a central shaft (not visible).

In FIG. 2B, the parts already described in respect of FIG. 2A, are indicated by the same reference numerals.

FIG. 2B further shows the body of mass 27 including a ring sector 28 which extends over a same angular section as the disc portion which forms the top part of the body of mass 27. Onto base plate 10 a central shaft 30 is fixedly connected which extends along the pivot axis P. On the outside of shaft 30 is a bearing 16 provided with an inner race fixedly connected to the shaft. The outer race of the bearing 16 is fixedly connected onto the body of mass 30. The ball bearing 16 thus effectively allows for a rotation of the rotor wheel about the pivot axis P. This pivoting mechanism 16 is single sided such that it forms a single pivotal connection between the rotor wheel and the base plate.

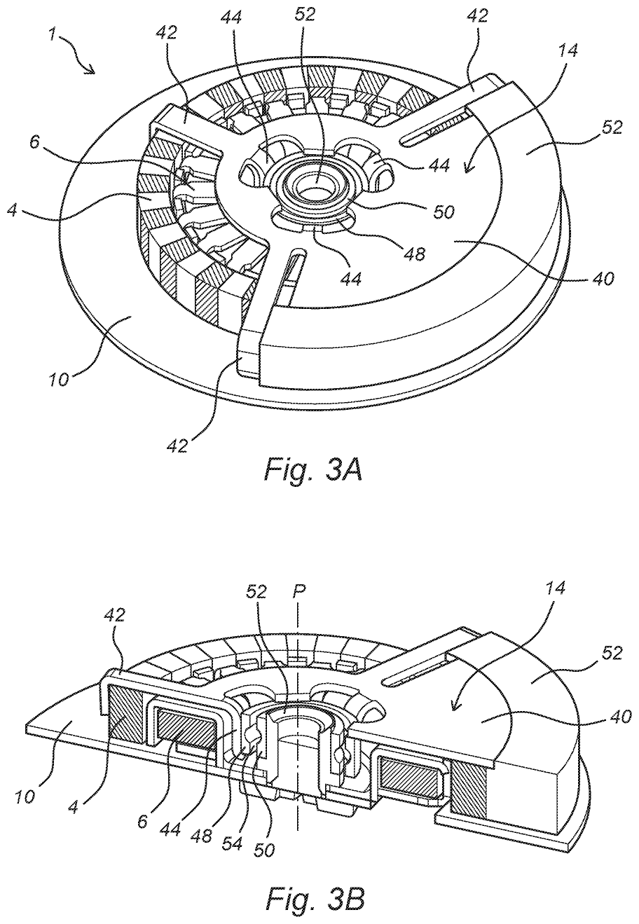

FIG. 3A shows a micro-power generator 1, which contains a multipole magnetic ring 4 and a stator 6, having similar properties as the multipole magnetic ring 4 and a stator 6 shown in FIG. 2A, except where stated otherwise below.

A mounting bracket 40 is clamped by virtue of arms 42 onto both the multipole magnetic ring 4 and the ring sector 52 which assembled together form a rotor wheel 14. The ring sector 52 functions herein as a body of mass. The inner arms 44 are clamped onto an outer race 48 of a ball bearing which further comprises an inner race 50 that is fixed onto a central shaft 52 that is connected onto the base plate 10.

The ring sector 52 has the size of an angular section of a ring of about 120°. Due to the ring sector 52, the rotor wheel 14 as a whole has a centre of mass which has an eccentric position with respect to the pivot axis.

In FIG. 3B, the parts already described in respect of FIG. 3A, are indicated by the same reference numerals.

FIG. 3B further shows the pivot axis P of the ball bearing 54; the central shaft 52 connected to the inner race 50 of the ball bearing, and the outer race of the ball bearing 48 connected to the clamping arms 44 of the mounting bracket 40. The ball bearing 54 thus effectively allows for a rotation of the rotor wheel about the pivot axis P. The pivoting mechanism based on ball bearing 54 and central shaft 52 is single sided such that it forms a single pivotal connection between the rotor wheel and the base plate.

The central shaft 52 aligns and fixes both the rotor wheel (inner race 50 of ball bearing) and the stator 6 to the base plate base plate 10. The alignment is based on form fits of the central shaft 52, the stator 6 and the ball bearing inner race 50. The fixation is achieved by riveting the top and bottom end of the shaft. Other methods for fixation could be used like gluing, (laser) welding, screwing or bending.

It will be clear that the invention is not limited to the embodiment examples presented and described here, but that numerous variants are possible within the scope of the appended claims, which will be obvious to a person skilled in the art. It is conceivable that various inventive concepts and/or technical measures of the embodiment variants described above may be combined completely or partially without departing from the inventive concepts described in the appended claims.

The verb “comprise” and conjugations thereof used in this patent specification mean not only “comprise”, but also the expressions “include”, “consist essentially of”, “formed by”, and conjugations thereof.

1. A micro-power generator suitable for a wearable, portable or moving electronic device, comprising:
a rotor wheel comprising a multipole magnetic array of a circular design, such as a multipole magnetic ring or disc, which multipole magnetic array has an inner radius r3 and an outer radius r4,
at least one stator which is a multipole metal stator comprising at least one stator coil having a plurality of windings for producing an electric voltage,
a base plate onto which the rotor wheel and the stator are mounted, wherein:
the at least one stator is fixedly connected to the base plate,
the rotor wheel is pivotally connected to the base plate by a pivoting mechanism which allows for a rotation of the rotor wheel about a pivot axis perpendicular to a first plane in which the rotor wheel extends, which pivot axis preferably has a concentric orientation to the rotor wheel,
and wherein the rotor wheel is provided on one side of the base plate, and the rotor wheel has a centre of mass that has an eccentric position with respect to the pivot axis.

2. The micro-power generator according to claim 1, wherein an angular section of the rotor wheel is provided with at least one body of mass, which body of mass is fixedly connected to the multipole magnetic array as an integral part of the rotor wheel, and which body of mass extends in a radial direction from the outer circumference of the multipole magnetic array.

3. The micro-power generator according to claim 2, wherein the angular section of the rotor wheel has a size which is determined by an angle theta which lies in the range of 60° and 300°, preferably of 90° and 180°, more preferably of 120° and 170°.

4. The micro-power generator according to claim 2, wherein the body of mass comprises a ring sector defined as an angular section of a ring that has a concentric orientation to the multipole magnetic array, wherein the ring sector has an outer radius r6, wherein r6 is larger than r4, and wherein the size of the angular section is determined by an angle theta which lies in the range of 60° and 300°, preferably of 90° and 180°, more preferably of 120° and 170°.

5. The micro-power generator according to claim 2, wherein the body of mass is connected to the multipole magnetic array by a substantially planar body which comprises either:
a mounting bracket that is releasably attached onto the body of mass and the multipole magnetic array; or
a disc portion that is fixedly attached to the body of mass and the multipole magnetic array.

6. The micro-power generator according to claim 1, wherein the pivoting mechanism is single sided such that it forms a single pivotal connection between the rotor wheel and the base plate.

7. The micro-power generator according to claim 1, wherein the pivoting mechanism for the rotor wheel comprises a central shaft which coincides with the pivot axis, and which central shaft is fixedly connected to the base plate.

8. The micro-power generator according to claim 1, wherein the pivoting mechanism for the rotor wheel comprises at least one friction reducing support element such as a bearing, which is mounted with a concentric orientation to the pivot axis, and preferably is mounted in the first plane and/or on one side of the first plane,
wherein further preferably the at least one friction reducing support element is a bearing that is positioned within the inner radius r3, for instance within the inner circumference of the stator.

9. The micro-power generator according to claim 8, wherein the at least one friction reducing support is a bearing, which is connected to the base plate and to the multipole magnetic array, and is mounted radially beyond the inner radius r3 of the multipole magnetic array, and preferably radially beyond the outer radius r4 of the multipole magnetic array.

10. The micro-power generator according to claim 1, wherein the multipole magnetic array and the stator of annular shape are mounted in a concentric orientation to each other and to the pivot axis, and both extend in the first plane on one side of the base plate.

11. The micro-power generator according to claim 1, wherein the stator has an annular shape which is delimited by an inner radius r1 and an outer radius r2, and the inner radius r3 of the multipole magnetic array is larger than the outer radius r2 of the stator.

12. The micro-power generator according to claim 1, wherein the centre of mass of the rotor wheel has a distance dcm, measured from the pivot axis and in a plane perpendicular to the pivot axis, which is equal to or larger than r3, preferably equal to or larger than (r3+r4)/2, and most preferably equal to or larger than r4.

13. The micro-power generator according to claim 2, wherein part of the body of mass is made from a metal having a density of 6000 kg/m3 or higher, and preferably is corrosion-resistant, such as Tungsten, brass and stainless steel.

14. The micro-power generator according to claim 2, wherein the body of mass has a weight ratio to the multipole magnetic ring or disc which is at least 1, preferably at least 2, and more preferably at least 4.

15. The micro-power generator according to claim 4, wherein the ring sector has a height equal to or larger than the height of the multipole magnetic ring or disc.

16. The micro-power generator according to claim 1, wherein the generator has a height of 2 up to 25 mm, and the rotor wheel has a diameter of 20 up to 100 mm, preferably 20 up to 35 mm.

17. The micro-power generator according to claim 1, wherein the multipole magnetic array preferably comprises 4 up to 100 magnetic poles, in particular 10 up to 60 magnetic poles.

18. The micro-power generator according to claim 1, wherein the stator coil is surrounded by an electromagnetic enclosure which interacts with the electromagnetic field of the rotor wheel in order to promote an induction effect in the windings of the stator coil.

19. The micro-power generator according to claim 1, wherein a first end and an opposed second end of the stator coil or stator coils are electrically connectable to an electrical circuit of a device for which the micro-power generator is suitable.

20. The micro-power generator according to claim 1, comprising at least two stators, wherein one stator produces a signal having a shifted phase with respect to the signal of the other stator.

21. A device, such as a watch, in particular a smartwatch, a wearable sensor or a sensor on moving objects, wherein the device comprises an electrical circuit and at least one micro-power generator according to claim 1, wherein the electrical circuit is connected to the micro-power generator.

22. The device according to claim 21,
wherein the micro-power generator is configured to produce at least one signal related to the output of the generator,
and wherein the electrical circuit of the device is powered by the micro-power generator
and wherein the electrical circuit comprises a processor that is configured to, directly or indirectly, receive the at least one signal produced by the micro-power generator and uses the signal, preferably for creating functions within the device and/or preferably to transform the signal into an output signal representative for the movement of the rotor wheel of the micro-power generator and/or the related motion of the device and/or the object to which the device is attached.

23. The device according to claim 21, wherein the processor produces an output signal which is representative for the activity, (rotational) speed, (rotational) direction, acceleration, travelled distance, revolutions turned, (incremental)position of the device or the (living) object to which the device is attached.

24. The device according to claim 22, which comprises a preprogramed signal processor, in which preferably at least one cross-reference between at least one signal related characteristic and at least one output signal related characteristic are stored, wherein the processor is configured to transform at least one signal into at least one output signal by making use of said preprogramed signal processor.

25. The device according to claim 21, in combination with a location tracking device, to generate combined data of both devices.

26. An assembly of a device according to claim 21 and a location tracking device, which assembly is configured to generate combined data from both devices.

27. The assembly according to claim 26, which is a wearable device for humans or animals, or a device that is mountable onto a moving object, such as a wheel of a moving object.
